(19) United States
(12) Patent Application Publication
(10) Pub. No.: US 2025/0285055 A1
(43) Pub. Date: Sep. 11, 2025

(54) ARTIFICIAL INTELLIGENCE (AI) AGENT FOR GENERATING AND EXECUTING PLANS FOR TASKS

(71) Applicant: Maplebear Inc., San Francisco, CA (US)

(72) Inventors: Li Tan, Fremont, CA (US); Yiqun Cheng, San Francisco, CA (US); Jiankun Song, New York, NY (US); Brandon Leonardo, Redwood City, CA (US); Peter Lin, San Francisco, CA (US)

(21) Appl. No.: 18/601,654

(22) Filed: Mar. 11, 2024

(51) Int. Cl. G06Q 10/0631

(52) U.S. Cl. CPC G06Q 10/06316

(57) ABSTRACT

An online system receives a description of a task and generates a prompt for a generative machine-learned model. The prompt includes the description of the task and a request for a sequence of actions associated with the task, and a list of candidate actions and attributes related to the list of candidate actions. The online system provides the prompt to a model serving system deployed with the machine-learning model for execution. The online system obtains a response from the model serving system to extract wherein at least one workflow including the sequence of actions once executed completes a portion of the task. The online system receives, as output from the machine-learned model, the sequence of actions associated with the description of the task. The sequence of actions is executed in order to complete at least a portion of the task.

### BACKGROUND

An online system includes various types of software applications and tools. The software applications and tools are used to perform tasks. For example, an online system electronically receives orders from users via a web application and fulfills the orders with one or more retailer stores using one or more API calls. Some tasks are complex and ambiguous, and it requires significant coordination to retrieve the relevant components and apply the components to perform the complex tasks. This process is error prone and requires a significant amount of time and resources for developers.

### SUMMARY

In accordance with one or more aspects of the disclosure, an online system receives a description of a task. The online system generates a prompt for a generative machine-learned model. In one or more embodiments, the prompt includes the description of the task and a request for a sequence of actions associated with the task, and a list of candidate actions and attributes related to the list of candidate actions. The online system provides the prompt to a model serving system deployed with the machine-learning model for execution. The online system obtains a response from the model serving system to extract wherein at least one workflow including the sequence of actions once executed completes a portion of the task. The online system receives, as output from the machine-learned model, the sequence of actions associated with the description of the task. The sequence of actions is executed in order to complete at least a portion of the task. The online system provides results of the execution to a client device associated with the task.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates an example diagram of an artificial intelligence (AI) agent, in accordance with one or more embodiments.

FIG. 4 illustrates an example plan action comprising one or more workflow actions, in accordance with one or more embodiments.

FIG. 5 is a flowchart for a method of obtaining a sequence of actions for performing a task in conjunction with an AI agent, in accordance with one or more embodiments.

### DETAILED DESCRIPTION

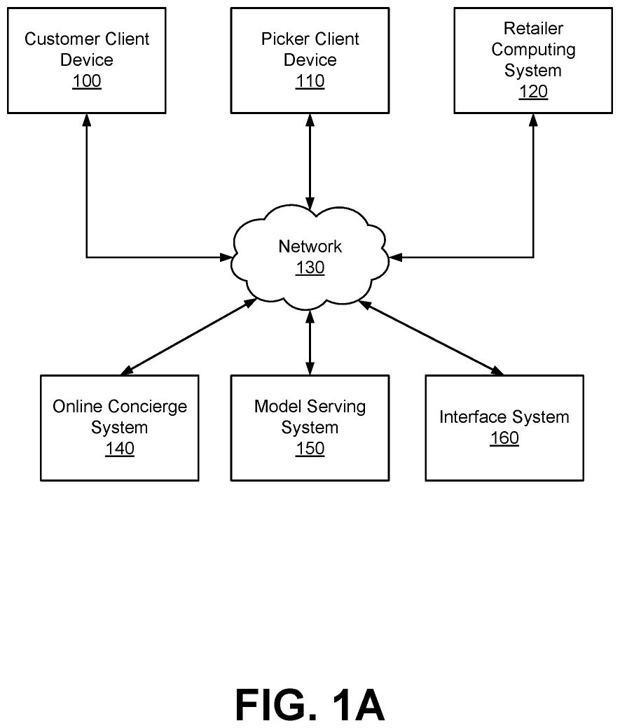

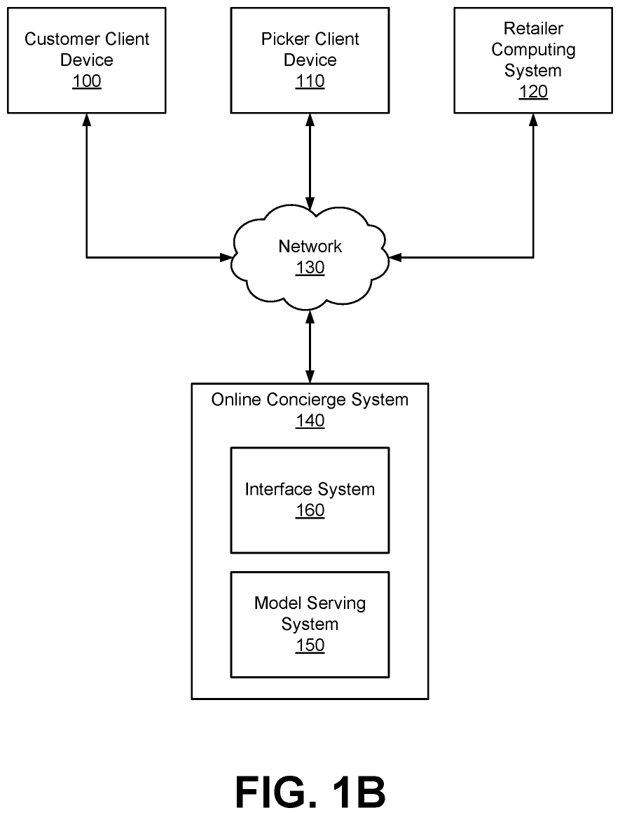

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

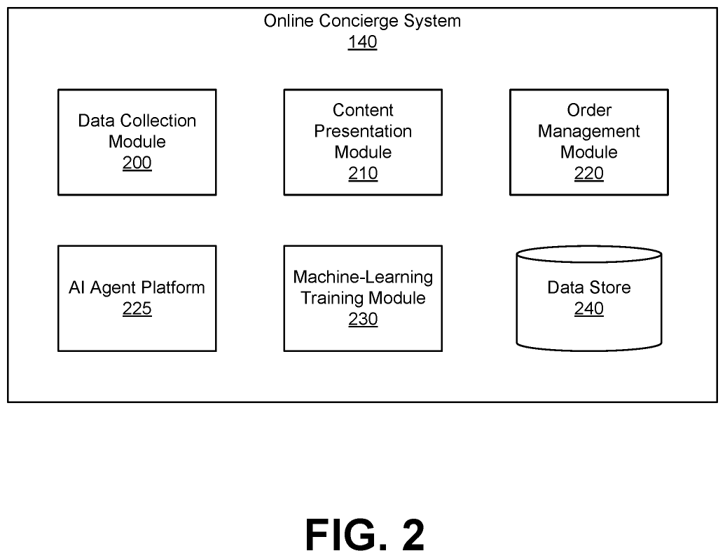

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

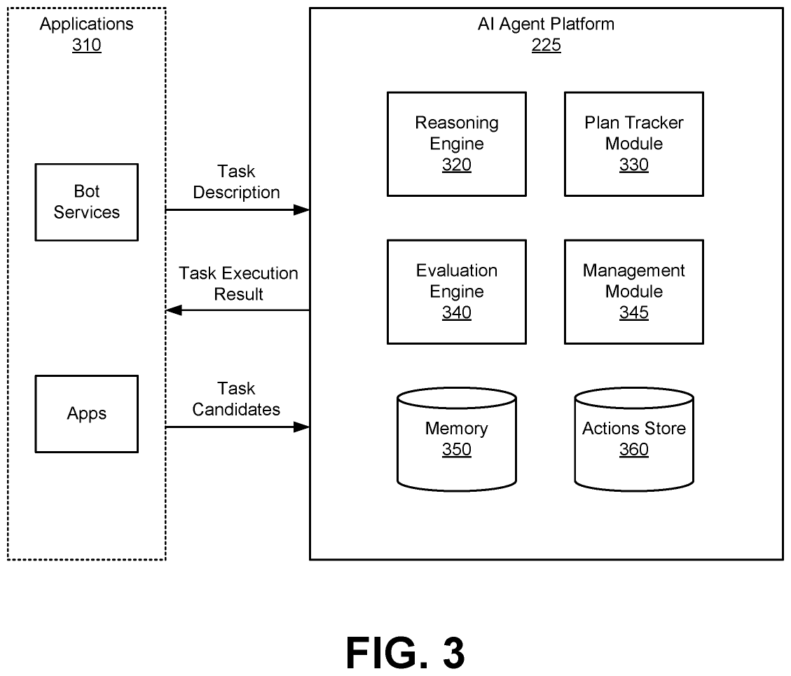

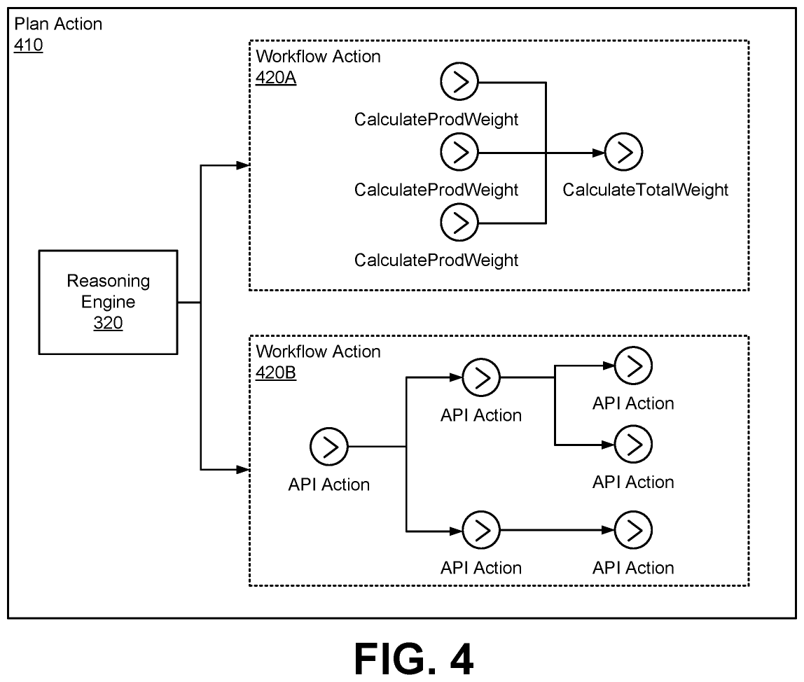

In one or more embodiments, the online system 140 deploys an autonomous AI agent platform that can assist applications and products of the online system 140 in performing actions and completing complex tasks. In one or more embodiments, the AI agent is powered by a generative AI model (e.g., LLM) and includes multiple components. The AI agent breaks up the task into multiple stages. In one instance, the AI agent supports actions at three different levels, the action level, the workflow level, and the plan level. This process is described with respect to FIGS. 3-4 below.

In one or more embodiments, the AI agent extracts instructions and intentions of tasks from inputs. The input can be in natural language or any other form. Based on the extracted tasks, the AI agent divides large tasks into smaller, more manageable subtasks, allowing for the efficient completion of complex tasks. Moreover, the AI agent conducts evaluation on past actions, such that the AI agent can “learn” from past errors and refine the errors for future steps, such that the quality of outcomes is continuously improved. The AI agent is also coupled to memory that is used to retrieve information, which includes a vector database storing long-term information and a cache for storing short-term information. After a plan has been extracted, the AI agent learns to call functions (e.g., external API's).

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The AI agent platform 225 is a generative AI model-powered platform that includes components for automated reasoning and planning for complicated tasks and executing the planned actions using one or more applications or tools of the online system 140. For example, an example task is “Calculate the total weight for a list of products including 10 apples each weighing 21b, 5 oranges each weighing 31b, and 20 bananas each weighing 11b.” In conventional online systems, many steps are performed to identify relevant actions (e.g., API calls, function calls, procedural calls) to execute for this task, review the requisite parameters for each action, gather the parameters, and execute the relevant actions to obtain a response.

Using the components of the AI agent platform 225 described herein, the AI agent platform 225 in conjunction with various tools and applications of the online system 140 receives a description of a task. The AI agent platform 225 generates a prompt for a machine-learned model, wherein the prompt includes the description of the task and a request for a sequence of actions associated with the task, a list of candidate actions and attributes related to the list of candidate actions. The prompt is provided to a model serving system deployed with the machine-learning model for execution. The AI agent platform 225 obtains a response from the model serving system and extracts at least one workflow including the sequence of actions associated with the description of the task. The AI agent platform 225 executes the sequence of actions in order to complete at least a portion of the task and provides results of the execution to a client device associated with the task.

As defined herein, an “action” can refer to at least one or a combination of a function call, a communication protocol-based call such as a REST API call, a remote procedural (RPCT) call, or a gRPC API call, performing search queries on the web or any other web applications, triggering inference of a machine-learned model, triggering training of a machine-learned model, downloading or uploading content items, and the like. While examples in the remainder of the specification focus on actions corresponding to API calls, it is appreciated that in other embodiments, the actions can be any other types of actions other than API calls. In many cases, an action follows some schema for, for example, binding to a communication protocol, code syntax, or any other type of structured format. By performing the method described herein, the sequence of actions output by the machine-learned model follows the schema required for triggering the action, and responses from one or more actions in the sequence can be verified and used as inputs to one or more subsequent actions in the sequence based on the schema.

FIG. 3 illustrates an example diagram of an artificial intelligence (AI) agent 225, in accordance with one or more embodiments. As illustrated in the architecture of FIG. 3, in one or more embodiments, the AI agent platform 225 includes a reasoning engine 320, a plan tracker module 330, and an evaluation engine 340, as well as any other components. The AI agent platform 225 also includes a memory store 350 and an actions datastore 360. The AI agent platform 225 may interact with one or more applications 310, including bot services or mobile or web applications.

The reasoning engine 320 obtains a plan including a sequence of actions that divide the task into multiple subtasks. Given a task, the reasoning engine 320 generates prompts to request a formulation of a plan to complete the task, and ingest action-specific descriptions (e.g., API-specific descriptions) to the machine-learned model. In one or more embodiments, the reasoning engine 320 supports the actions at three different levels as described in detail below and in conjunction with FIG. 4.

A first level is a single action (e.g., API, RPC, gRPC call). For example, the action may be to invoke an API and digest the response. Given a task and the description in natural language, the reasoning engine 320 determines whether to call a given API, call it correctly, and respond appropriately to API returns based on the API's description and the context of the task. For example, a task may be “What is my order?” or “What are my orders in the last 2 weeks?” The reasoning engine 320 identifies the API call required for responding to these tasks, where the outputs from the model comply with the schema for making the call. For example, the output may follow JSON schema for a REST API call or Proto Buffer schema for a gRPC call.

A second level is a workflow action. A workflow action combines a sequence of actions in performing a subtask for the task. In one or more embodiments, the sequence of actions in the workflow are predefined or assembled by the reasoning engine in conjunction with a generative machine-learned model. As an example, a first workflow may include a sequence of API calls for managing membership of users, while a second workflow may include a sequence of API calls for assisting with payment problems. As yet another example, a re-order workflow includes an API call to check the most recent order to identify the items for repurchase, a second API call to check the current order status of the user, and a third API call to add new items to the order of the user.

FIG. 4 illustrates an example plan action comprising one or more workflow actions, in accordance with one or more embodiments. FIG. 4 illustrates example workflow actions 420A and 420B. Specifically, workflow action 420A is for calculating a total weight of items in a user's order and an example input to the machine-learned model and output from the model is reproduced below. As shown in the example input below, the reasoning engine 320 prepares a prompt to the machine-learned model that includes a list of candidate API calls and attributes for the candidate functions (within the “<FUNCTIONS> . . . </FUNCTIONS>” tags), inputs for the task including a list of items (e.g., 10 apples each with 2 lb weight, 5 oranges each with 3 lb weight, and 20 bananas each with 1 lb weight within the “<INPUT> . . . </INPUT>” tags), and instructions to calculate the total weight for the list of items in the input (within the “[INST] . . . [/INST]” tags). The attributes for a candidate function includes the name of the function, description of the function, and arguments for the function, and expected output types for the function.

As shown in the example output below and in FIG. 4, the extracted workflow action is to make a first call to the “CalculateProductWeight” function with the attributes of the first item (i.e., 10 apples) in the input to compute the weight of the first item, make a second call to the “CalculateProductWeight” function with the attributes of the second item (i.e., 5 oranges) in the input to compute the weight of the second item, and make a third call to the “CalculateProduct Weight” function with the attributes of the third item (i.e., 20 bananas) in the input to compute the weight of the third item. The last action is to call the “CalculateTotalWeight” function with the weights of each of the first item, second item, and third item to compute the total weight of items in the user's order. The extracted sequence of actions follows the required schema for invoking the functions.

### Input to the Model

### <FUNCTIONS> [{

“name”: “get email by customer id”, “description”: “Fetch the email of a customer by customer id.”, “arguments”: [{“name”: “customer id”, “type”: “string”, “description”: “The id of the customer. “}], “output”: {“type”: “string”, “description”: “The email of the customer.”}},
{“name”: “calculateTotalWeight”, “description”: “Calculate the total weight for all products”, “arguments”: [{“name”: “weights”, “type”: “list”, “description”: “List of individual total weight for each product”}], “output”: {“type”: “integer”, “description”: “Total weight for all products”}},
{“name”: “calculateProductWeight”, “description”: “Calculate total weight for one specific product with quantity”, “arguments”: [{“name”: “product”, “type”: “dictionary”, “description”: “Product information”}], “output”: {“type”: “integer”, “description”: “Total weight for a specific product”}},
{“name”: “findPreferredCategory”, “description”: “Finds a customer's preferred product category from past purchases”, “arguments”: [{“name”: “pastPurchases”, “type”: “list”, “description”: “List of past purchases with their product categories”}], “output”: {“type”: “string”, “description”: “The preferred product category”}},
{“name”: “retrieve user shopping cart”, “description”: “Retrieves the shopping cart of the user”, “arguments”: [{“name”: “user id”, “type”: “string”, “description”: “User's unique identifier”}], “output”: {“type”: “Cart”, “description”: “Shopping cart of the user including the list of items”}}]</FUNCTIONS>
   <INPUT>[{“name”: “products”, “value”: [{“name”: “Apple”, “weight”: 2, “quantity”: 10}, {“name”: “Orange”, “weight”: 3, “quantity”: 5}, {“name”: “Banana”, “weight”: 1, “quantity”: 20}]}]</INPUT>
   [INST] Calculate total weight for a list of products. [/INST]
   Output from the Model

### Generated Assistant Response:

[{“node_id”: 0, “function”: “calculateProductWeight”, “arguments”: [{“name”: “product”, “value”: “{{input.products[0]}}”}], “preconditions”: [ ]},
{“node_id”: 1, “function”: “calculateProductWeight”, “arguments”: [{“name”: “product”, “value”: “{{input.products[1]}} “}], “preconditions”: [ ]},
{“node_id”: 2, “function”: “calculateProductWeight”, “arguments”: [{“name”: “product”, “value”: “{{input.products[2]}} “}], “preconditions”: [ ]},
{“node_id”: 3, “function”: “calculateTotalWeight”, “arguments”: [{“name”: “weights”, “value”: [“{{0.output}}”, “{{1.output}}”, “{{2.output}}”]}],”

In addition, one way of processing tasks is to formulate a text-based plan and map the text-based plan to individual function calls. However, this results in information loss with respect to how the function calls are made. Moreover, text-based plans have no restrictions on the inputs and outputs that are provided to the functions. In the method described herein, the reasoning engine 320 in conjunction with the generative machine-learned model formulates a plan including one or more workflow actions, where a workflow action specifies an action graph representing the sequence of actions without intermediate steps. The workflow is dynamically generated and specifies how the inputs and outputs of each call are connected with each other. Thus, when the workflow is executed, it is deterministic.

Returning to the reasoning engine 320, a third level is a plan action. The reasoning engine 320 generates a plan action to handle high-level tasks through planning and reflection to decompose the task into one or more workflow actions. In one or more embodiments, the AI agent platform 225 leverages multiple API's to retrieve information for planning and iteratively refine the results. For example, the membership renewal plan includes a first workflow with a sequence of actions to call the “user status” function, then a call to the “membership status” function, and then a call to the “understand available payment options” function. The membership renewal plan may have a second workflow with a sequence of actions to determine the optimal payment method based on the available data, a third workflow for obtaining customer confirmation, and a final API call to renew the membership. As shown in FIG. 4, the plan action 410 includes multiple workflow actions 420A, 420B. In one or more embodiments, a plan divides the task into different workflows when an intermediate step such as a user interaction or decision-making is required in order to proceed with the next action. The plan tracker module 330 triggers execution of the plan and manages execution of the plan. In one or more embodiments, the plan tracker module 330 coordinates between various applications and tools of the online system 140 to execute the plan generated by the reasoning engine 320. The plan tracker module 330 may control a collection of expert modules, including calculators, external API's, and the like to execute the plan for the task. For example, for a given sequence of API calls (i.e., a workflow action), the plan tracker module 330 may invoke the API's in sequence and monitor the responses from an API to determine whether the plan action is being executed correctly. In one or more embodiments, a plan is configured with one or more “checkpoints,” where intermediate results of the plan are evaluated. A checkpoint may correspond to a period in time after an API call, a period in time after a workflow action execution, and the like. The plan tracker module 330 also manages checkpoints during execution and obtains intermediate results at the checkpoints for evaluation. For example, a checkpoint may be at a point after workflow action 420A is completed and before workflow action 420B is executed.

The evaluation engine 340 evaluates results during or after execution of the plan for a task. The evaluation of performance is important because the evaluations can help the autonomous AI agent to learn from past errors and therefore, make better decisions in the future. In one or more embodiments, intermediate results obtained by the plan tracker module 330 at a checkpoint (e.g., after an API call, after a workflow action execution) is evaluated by the evaluation engine 340. If the results are satisfactory (e.g., results align with expected output type or expected response), the evaluation engine 340 can provide the evaluation to the plan tracker module 330 such that the execution can continue. If the results are unsatisfactory (e.g., results do not align with expected output type or expected response), the evaluation engine 340 can alert the plan tracker module 330 to stop execution of the plan. The evaluation engine 340 can provide the evaluation to the reasoning engine 320, such that the reasoning engine 320 can revise the plan or workflow actions to correct for the error.

The memory datastore 350 stores information for the creation and execution of plans, which may originate from in-context learning (short-term memory) and external storage. In one or more embodiments, the memory datastore 350 includes a vector database for storing long-term data, which includes indexed API endpoints and attributes (e.g., parameters) from a set of task candidates that were previously completed. In one or more embodiments, the memory datastore 350 includes a cache for storing short-term data, for example, sourced from in-context learning. The data from short-term data may be indexed into the vector database periodically.

The management module 345 manages and updates the components of the AI agent platform 225. In one or more embodiments, the management module 345 is responsible for maintaining the memory datastore 350 and identifies task candidates and API endpoints to index and store in the memory datastore 350. In one or more embodiments, the management module 345 is responsible for performing fine-tuning parameters of the machine-learned model or tuning the prompt templates to increase the performance of plan generation and execution.

During fine-tuning of the machine-learned model, the management module 345 provides multiple instances of training data. A data instance includes a set of inputs and expected outputs. For example, in relation to the workflow action 420A, a data instance may include a set of inputs including a list of candidate actions, inputs for the task candidate (3 mangoes each with 4 lb weight and 10 strawberries each with 0.5 lb weight), and an instruction to the model, as shown in the example data instance below. The task candidate is to calculate the total weight for a list of products. The data instance may further include expected outputs (referenced result) including the sequence of actions for the desired workflow. In the example below, the reference sequence of actions is to call the “CalculateProductWeight” function with the inputs for the first item and call the function with the inputs for the second item, and then call the “CalculateTotalWeight” function with the weights for the first item and the second item.

The management module 345 configures fine-tuning of the machine-learned model with additional data instances. During fine-tuning, the inputs of data instances are provided to the model to generate estimated outputs. A loss function is computed between the estimated outputs and the expected outputs. One or more error terms are obtained from the loss function and backpropagated to update the parameters. In this manner, the machine-learned model learns over time how to construct the plan actions, the workflow actions, and individual actions in response to receiving a task.

### Input to the Model

### <FUNCTIONS> [{

“name”: “get email by customer id”, “description”: “Fetch the email of a customer by customer id. “, “arguments”: [{“name”: “customer id”, “type”: “string”, “description”: “The id of the customer. “}], “output”: {“type”: “string”, “description”: “The email of the customer. “}},
{“name”: “calculateTotalWeight”, “description”: “Calculate the total weight for all products”, “arguments”: [{“name”: “weights”, “type”: “list”, “description”: “List of individual total weight for each product”}], “output”: {“type”: “integer”, “description”: “Total weight for all products”}},
{“name”: “calculateProductWeight”, “description”: “Calculate total weight for one specific product with quantity”, “arguments”: [{“name”: “product”, “type”: “dictionary”, “description”: “Product information”}], “output”: {“type”: “integer”, “description”: “Total weight for a specific product”}},
{“name”: “retrieve user shopping cart”, “description”: “Retrieves the shopping cart of the user”, “arguments”: [{“name”: “user id”, “type”: “string”, “description”: “User's unique identifier”}], “output”: {“type”: “Cart”, “description”: “Shopping cart of the user including the list of items”}}]</FUNCTIONS>
   <INPUT> [{“name”: “products”, “value”: [{“name”: “Mango”, “weight”: 4, “quantity”: 3}, {“name”: “Strawberry”, “weight”: 0.5, “quantity”: 10}]}]</INPUT>
   [INST] Calculate total weight for a list of products. [/INST]

### Referenced Result

### Correct Assistant Response:

[

{
“node_id”: 0,
   “function”: “calculateTotalWeight”,
   “arguments”: [{“name”: [
      {
         “weights”,
         “value”: [
         “{{1.output}}”,
         “{{2.output}}”
         ]
      }
   ],
   “preconditions”: [ ]
},
{
   “node_id”: 1,
   “function”: “calculateProductWeight”,
   “arguments”: [
      {
         “name”: “product”,
         “value”: “{{input.products[0]}}”
      }
   ],
   “preconditions”: [ ]
},
{
   “node_id”: 2,
   “function”: “calculateProductWeight”,
   “arguments”: [
      {
         “name”: “product”,
         “value”: “{{input.products[1]}}”
      }
   ],
“preconditions”: [ ]}]

]

]

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. For example, the machine-learning training module 230 may obtain a pre-trained transformer language model and further fine tune the parameters of the transformer model using training data stored in the data store 240. The machine-learning training module 230 may provide the model to the model serving system 150 for deployment.

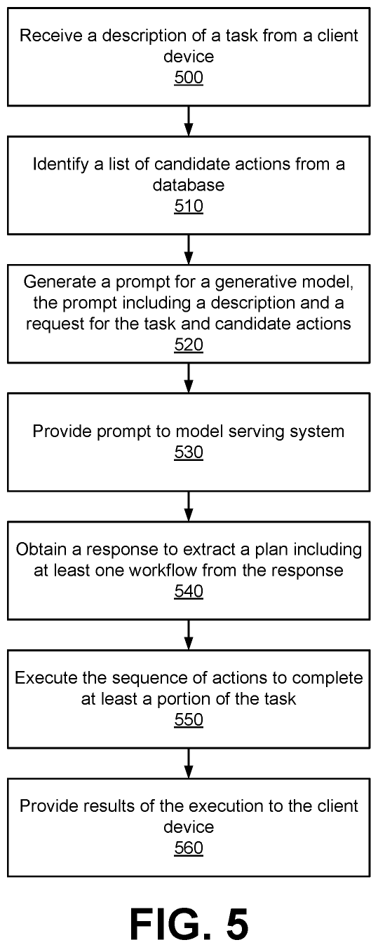

FIG. 5 is a flowchart for a method of obtaining a sequence of actions for a task in conjunction with an AI agent platform 225, in accordance with one or more embodiments. Alternative embodiments may include more, fewer, or different steps from those illustrated in FIG. 5, and the steps may be performed in a different order from that illustrated in FIG. 5. These steps may be performed by an online system (e.g., the online system 140 and/or AI agent platform 225). Additionally, each of these steps may be performed automatically by the online system 140 without human intervention.

The online system 140 receives 500, from a client device, a description of a task. Responsive to receiving the description of the task, the online system 140 identifies 510 a list of candidate actions from a database. The online system 140 generates 520 a prompt for a generative machine-learned model. In one or more embodiments, the prompt includes the description of the task, a request for a plan for the task, and the list of candidate actions and attributes related to the list of candidate actions. The online system 140 provides 530 the prompt to a model serving system 150 deployed with the machine-learning model for execution. The online system 140 obtains 540 a response from the model serving system 150 to extract a plan including at least one workflow. In one or more embodiments, the workflow includes the sequence of actions associated with the description of the task. The online system 140 executes 550 the sequence of actions to complete at least a portion of the task. The online system 140 provides 560 the results of the execution to the client device.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
receiving, from a client device, a description of a task;
responsive to receiving the description of the task, identifying a list of candidate actions from a database;
generating a prompt for a generative machine-learned model, the prompt including the description of the task, a request for a plan for the task, and the list of candidate actions and attributes related to the list of candidate actions;
providing the prompt to a model serving system deployed with the machine-learned model for execution;
obtaining a response from the model serving system to extract a plan including at least one workflow from the response, wherein the workflow includes the sequence of actions associated with the description of the task, wherein an action in the sequence of actions of the workflow is at least one or a combination of a function call or an application programming interface (API) call;
executing the sequence of actions to complete at least a portion of the task; and
providing results of the execution to the client device.

2. The method of claim 1, wherein the API call follows a REST communication protocol or a gRPC communication protocol.

3. The method of claim 1, wherein the action in the sequence of actions for the workflow follows a schema for the function call or the API call, and wherein an output of the action is an input to a second action in the sequence.

4. The method of claim 1, wherein the plan includes at least one checkpoint, and the method further comprising:
obtaining intermediate results of executing the plan at the checkpoint;
evaluating the intermediate results to identify whether the intermediate results match an expected output; and
responsive to determining that the intermediate results match the expected output, executing a remaining portion of the plan.

5. The method of claim 1, wherein the plan includes at least one checkpoint, and the method further comprising:
obtaining intermediate results of executing the plan at the checkpoint;
evaluating the intermediate results to determine whether the intermediate results match an expected output;
responsive to determining that the intermediate results do not match the expected output, terminating execution of the plan; and
updating the plan to address the intermediate results.

6. The method of claim 1, wherein the plan includes a second workflow including another sequence of actions.

7. The method of claim 6, wherein the plan includes a checkpoint, and the further comprising:
after executing the sequence of actions, receiving one or more user inputs from a user; and
executing the another sequence of actions of the second workflow.

8. The method of claim 1, further comprising:
obtaining a set of data instances, a data instance including a set of inputs describing a task candidate and expected outputs including a desired sequence of actions for completing at least a portion of the task candidate, the desired sequence of actions following a schema for a protocol,
generating an estimated output by inputting the set of inputs to the machine-learned model;
obtaining a loss function indicating a difference between the estimated output and the expected outputs; and
updating parameters of the machine-learned model based on terms obtained from the loss function.

9. The method of claim 1, wherein the attributes related to a candidate action in the prompt includes one or a combination of a name of the candidate action, a description of the candidate action, inputs for the candidate action, and expected output type for the candidate action.

10. The method of claim 1, wherein the sequence of actions are represented as a set of nodes.

11. A non-transitory computer-readable memory storing executable computer program instructions, the instructions executable to perform operations comprising:
receiving, from a client device, a description of a task;
responsive to receiving the description of the task, identifying a list of candidate actions from a database;
generating a prompt for a generative machine-learned model, the prompt including the description of the task, a request for a plan for the task, and the list of candidate actions and attributes related to the list of candidate actions;
providing the prompt to a model serving system deployed with the machine-learned model for execution;
obtaining a response from the model serving system to extract a plan including at least one workflow from the response, wherein the workflow includes the sequence of actions associated with the description of the task, wherein an action in the sequence of actions of the workflow is at least one or a combination of a function call or an application programming interface (API) call;
executing the sequence of actions to complete at least a portion of the task; and
providing results of the execution to the client device.

12. The non-transitory computer-readable memory of claim 11, wherein the API call follows a REST communication protocol or a gRPC communication protocol.

13. The non-transitory computer-readable memory of claim 12, wherein the action in the sequence of actions for the workflow follows a schema for the function call or the API call, and wherein an output of the action is an input to a second action in the sequence.

14. The non-transitory computer-readable memory of claim 11, wherein the plan includes at least one checkpoint, and the operations further comprising:
obtaining intermediate results of executing the plan at the checkpoint;
evaluating the intermediate results to identify whether the intermediate results match an expected output; and
responsive to determining that the intermediate results match the expected output, executing a remaining portion of the plan.

15. The non-transitory computer-readable memory of claim 11, wherein the plan includes at least one checkpoint, and the operations further comprising:
obtaining intermediate results of executing the plan at the checkpoint;
evaluating the intermediate results to determine whether the intermediate results match an expected output;
responsive to determining that the intermediate results do not match the expected output, terminating execution of the plan; and
updating the plan to address the intermediate results.

16. The non-transitory computer-readable memory of claim 11, wherein the plan includes a second workflow including another sequence of actions.

17. The non-transitory computer-readable memory of claim 16, wherein the plan includes a checkpoint, and the further comprising:
after executing the sequence of actions, receiving one or more user inputs from a user; and
executing the another sequence of actions of the second workflow.

18. The non-transitory computer-readable memory of claim 11, the operations further comprising:
obtaining a set of data instances, a data instance including a set of inputs describing a task candidate and expected outputs including a desired sequence of actions for completing at least a portion of the task candidate, the desired sequence of actions following a schema for a protocol,
generating an estimated output by inputting the set of inputs to the machine-learned model;
obtaining a loss function indicating a difference between the estimated output and the expected outputs; and
updating parameters of the machine-learned model based on terms obtained from the loss function.

19. The non-transitory computer-readable memory of claim 11, wherein the attributes related to a candidate action in the prompt includes one or a combination of a name of the candidate action, a description of the candidate action, inputs for the candidate action, and expected output type for the candidate action.

20. A computer system, comprising:
a computer processor for executing computer program instructions; and
a non-transitory computer-readable memory storing executable computer program instructions, the instructions executable to perform operations comprising:
receiving, from a client device, a description of a task;
responsive to receiving the description of the task, identifying a list of candidate actions from a database;
generating a prompt for a generative machine-learned model, the prompt including the description of the task, a request for a plan for the task, and the list of candidate actions and attributes related to the list of candidate actions;
providing the prompt to a model serving system deployed with the machine-learning model for execution;
obtaining a response from the model serving system to extract a plan including at least one workflow from the response, wherein the workflow includes the sequence of actions associated with the description of the task;
executing the sequence of actions to complete at least a portion of the task; and
providing results of the execution to the client device.
